(19) United States
(12) Patent Application Publication
(10) Pub. No.: US 2015/0260286 A1
(43) Pub. Date: Sep. 17, 2015

(54) DOWNSHIFT INDICATION LIGHT FOR FUEL OPTIMIZATION ON ENGINES WITH ACTIVE FUEL MANAGEMENT

(71) Applicant: GM Global Technology Operations LLC, Detroit, MI (US)

(72) Inventors: Larry D. Laws, Macomb, MI (US); Ronald W. Knoebel, Waterford, MI (US); Craig W. Stumpf, Bloomfield Hills, MI (US); Daniel Molnar, Brighton, MI (US)

(73) Assignee: GM Global Technology Operations LLC, Detroit, MI (US)

(21) Appl. No.: 14/204,046

(22) Filed: Mar. 11, 2014

(51) Int. Cl. F16H 63/42

(52) U.S. Cl. CPC F16H 63/42; F16H 2063/426

(57) ABSTRACT

A system includes a control module that determines a current gear of a vehicle. An active fuel management (AFM) and shift module determines an upshift vehicle speed threshold and a downshift vehicle speed threshold based in part on the current gear, selectively provides an indication to a driver to perform a vehicle upshift or an indication to the driver to perform a vehicle downshift based on a comparison between a vehicle speed and each of the upshift vehicle speed threshold and a downshift vehicle speed threshold, and selectively provides the indication to the driver to perform the vehicle downshift based on a determination that AFM is not enabled in the current gear and that AFM would be enabled in response to the vehicle downshift.

### FIELD

The present disclosure relates to active fuel management.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Internal combustion engines may include engine control systems that deactivate cylinders under low load situations. For example, an eight cylinder engine can be operated using four cylinders to improve fuel economy by reducing pumping losses. This process is generally referred to as active fuel management (AFM). Operation using all of the engine cylinders is referred to as an “activated” mode (AFM disabled). A “deactivated” mode (AFM enabled) refers to operation using less than all of the cylinders of the engine (i.e. one or more cylinders not active). In the deactivated mode, there are fewer cylinders operating. Engine efficiency is increased as a result of less engine pumping loss and higher combustion efficiency.

### SUMMARY

A system includes a control module that determines a current gear of a vehicle. An active fuel management (AFM) and shift module determines an upshift vehicle speed threshold and a downshift vehicle speed threshold based in part on the current gear, selectively provides an indication to a driver to perform a vehicle upshift or an indication to the driver to perform a vehicle downshift based on a comparison between a vehicle speed and each of the upshift vehicle speed threshold and a downshift vehicle speed threshold, and selectively provides the indication to the driver to perform the vehicle downshift based on a determination that AFM is not enabled in the current gear and that AFM would be enabled in response to the vehicle downshift.

A method includes determining a current gear of a vehicle, determining an upshift vehicle speed threshold and a downshift vehicle speed threshold based in part on the current gear, selectively providing an indication to a driver to perform a vehicle upshift or an indication to the driver to perform a vehicle downshift based on a comparison between a vehicle speed and each of the upshift vehicle speed threshold and a downshift vehicle speed threshold, and selectively providing the indication to the driver to perform the vehicle downshift based on a determination that AFM is not enabled in the current gear and that AFM would be enabled in response to the vehicle downshift.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example engine system according to the present disclosure;

FIG. 2 is a functional block diagram of an example engine control module according to the present disclosure; and

FIG. 3 is a flowchart illustrating an example AFM shift recommendation method according to the present disclosure.

In the drawings, reference numbers may be reused to identify similar and/or identical elements.

### DETAILED DESCRIPTION

In engine control systems with active fuel management (AFM), one or more cylinders in an engine can be turned off (e.g., under partial load conditions) to improve fuel economy. Typically, a vehicle will operate with better fuel economy with a lower gear ratio (i.e., while operating in a higher gear) than with a higher gear ratio (i.e., while operating in a lower gear). For example, a second drive gear has a lower gear ratio than a first drive gear and therefore generally provides better fuel economy.

However, in some conditions, operating in the lower gear (and the higher gear ratio) with AFM enabled may provide better fuel economy than operating in the higher gear (and the lower gear ratio) in the same conditions. An engine control system according to the present disclosure determines whether shifting to a higher gear ratio (i.e., downshifting) with AFM enabled would improve fuel economy over a current lower gear ratio. The engine control system may provide an indication that suggests that a driver downshift to improve fuel economy.

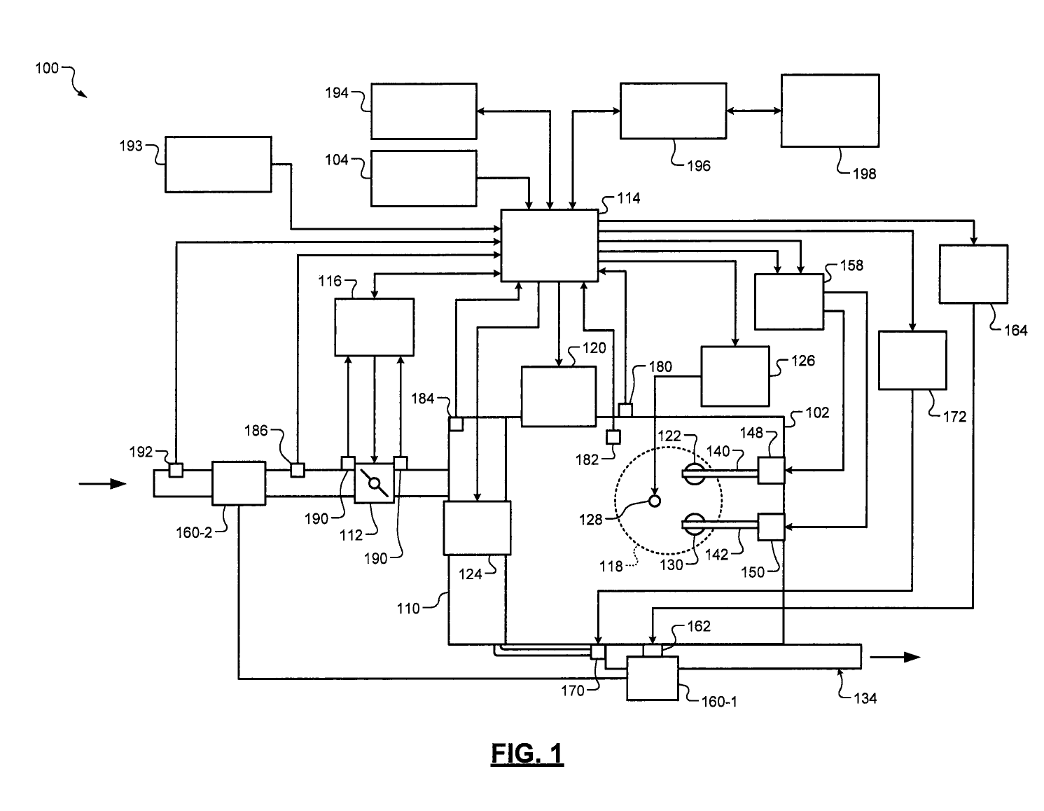

Referring now to FIG. 1, a functional block diagram of an example engine system 100 is presented. The engine system 100 includes an engine 102 that combusts an air/fuel mixture to produce drive torque for a vehicle based on driver input from a driver input module 104. The engine 102 may be a gasoline spark ignition internal combustion engine.

Air is drawn into an intake manifold 110 through a throttle valve 112. For example only, the throttle valve 112 may include a butterfly valve having a rotatable blade. An engine control module (ECM) 114 controls a throttle actuator module 116, which regulates opening of the throttle valve 112 to control the amount of air drawn into the intake manifold 110.

Air from the intake manifold 110 is drawn into cylinders of the engine 102. While the engine 102 may include multiple cylinders, for illustration purposes a single representative cylinder 118 is shown. For example only, the engine 102 may include 2, 3, 4, 5, 6, 8, 10, and/or 12 cylinders. The ECM 114 may instruct a cylinder actuator module 120 to selectively deactivate some of the cylinders, which may improve fuel economy under certain engine operating conditions.

The engine 102 may operate using a four-stroke cycle. The four strokes, described below, may be referred to as the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes.

During the intake stroke, air from the intake manifold 110 is drawn into the cylinder 118 through an intake valve 122. The ECM 114 controls a fuel actuator module 124, which regulates fuel injection to achieve a target air/fuel ratio. Fuel may be injected into the intake manifold 110 at a central location or at multiple locations, such as near the intake valve 122 of each of the cylinders. In various implementations (not shown), fuel may be injected directly into the cylinders or into mixing chambers associated with the cylinders. The fuel actuator module 124 may halt injection of fuel to cylinders that are deactivated.

The injected fuel mixes with air and creates an air/fuel mixture in the cylinder 118. During the compression stroke, a piston (not shown) within the cylinder 118 compresses the air/fuel mixture. A spark actuator module 126 energizes a spark plug 128 in the cylinder 118 based on a signal from the ECM 114, which ignites the air/fuel mixture. The timing of the spark may be specified relative to the time when the piston is at its topmost position, referred to as top dead center (TDC).

The spark actuator module 126 may be controlled by a timing signal specifying how far before or after TDC to generate the spark. Because piston position is directly related to crankshaft rotation, operation of the spark actuator module 126 may be synchronized with crankshaft angle. Generating spark may be referred to as a firing event. The spark actuator module 126 may have the ability to vary the timing of the spark for each firing event. The spark actuator module 126 may vary the spark timing for a next firing event when the spark timing is changed between a last firing event and the next firing event. The spark actuator module 126 may halt provision of spark to deactivated cylinders.

During the combustion stroke, the combustion of the air/fuel mixture drives the piston away from TDC, thereby driving the crankshaft. The combustion stroke may be defined as the time between the piston reaching TDC and the time at which the piston reaches bottom dead center (BDC). During the exhaust stroke, the piston begins moving away from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118). In various other implementations, the intake valve 122 and/or the exhaust valve 130 may be controlled by devices other than camshafts, such as camless valve actuators. The cylinder actuator module 120 may deactivate the cylinder 118 by disabling opening of the intake valve 122 and/or the exhaust valve 130.

The time when the intake valve 122 is opened may be varied with respect to piston TDC by an intake cam phaser 148. The time when the exhaust valve 130 is opened may be varied with respect to piston TDC by an exhaust cam phaser 150. A phaser actuator module 158 may control the intake cam phaser 148 and the exhaust cam phaser 150 based on signals from the ECM 114. When implemented, variable valve lift (not shown) may also be controlled by the phaser actuator module 158.

The engine system 100 may include a turbocharger that includes a hot turbine 160-1 that is powered by hot exhaust gases flowing through the exhaust system 134. The turbocharger also includes a cold air compressor 160-2 that is driven by the turbine 160-1. The compressor 160-2 compresses air leading into the throttle valve 112. In various implementations, a supercharger (not shown), driven by the crankshaft, may compress air from the throttle valve 112 and deliver the compressed air to the intake manifold 110.

A wastegate 162 may allow exhaust to bypass the turbine 160-1, thereby reducing the boost (the amount of intake air compression) provided by the turbocharger. A boost actuator module 164 may control the boost of the turbocharger by controlling opening of the wastegate 162. In various implementations, two or more turbochargers may be implemented and may be controlled by the boost actuator module 164.

An air cooler (not shown) may transfer heat from the compressed air charge to a cooling medium, such as engine coolant or air. An air cooler that cools the compressed air charge using engine coolant may be referred to as an intercooler. An air cooler that cools the compressed air charge using air may be referred to as a charge air cooler. The compressed air charge may receive heat, for example, via compression and/or from components of the exhaust system 134. Although shown separated for purposes of illustration, the turbine 160-1 and the compressor 160-2 may be attached to each other, placing intake air in close proximity to hot exhaust.

The engine system 100 may include an exhaust gas recirculation (EGR) valve 170, which selectively redirects exhaust gas back to the intake manifold 110. The EGR valve 170 may be located upstream of the turbocharger's turbine 160-1. The EGR valve 170 may be controlled by an EGR actuator module 172 based on signals from the ECM 114.

A position of the crankshaft may be measured using a crankshaft position sensor 180. A rotational speed of the crankshaft (an engine speed) may be determined based on the crankshaft position. A temperature of the engine coolant may be measured using an engine coolant temperature (ECT) sensor 182. The ECT sensor 182 may be located within the engine 102 or at other locations where the coolant is circulated, such as a radiator (not shown).

A pressure within the intake manifold 110 may be measured using a manifold absolute pressure (MAP) sensor 184. In various implementations, engine vacuum, which is the difference between ambient air pressure and the pressure within the intake manifold 110, may be measured. A mass flow rate of air flowing into the intake manifold 110 may be measured using a mass air flow (MAF) sensor 186. In various implementations, the MAF sensor 186 may be located in a housing that also includes the throttle valve 112.

The throttle actuator module 116 may monitor the position of the throttle valve 112 using one or more throttle position sensors (TPS) 190. An ambient temperature of air being drawn into the engine 102 may be measured using an intake air temperature (IAT) sensor 192. The engine system 100 may also include one or more other sensors 193, such as an ambient humidity sensor, one or more knock sensors, a compressor outlet pressure sensor and/or a throttle inlet pressure sensor, a wastegate position sensor, an EGR position sensor, and/or one or more other suitable sensors. The ECM 114 may use signals from the sensors to make control decisions for the engine system 100.

The ECM 114 may communicate with a transmission control module 194 to coordinate shifting gears in a transmission (not shown). For example, the ECM 114 may reduce engine torque during a gear shift. The ECM 114 may communicate with a hybrid control module 196 to coordinate operation of the engine 102 and an electric motor 198.

The electric motor 198 may also function as a generator, and may be used to produce electrical energy for use by vehicle electrical systems and/or for storage in a battery. In various implementations, various functions of the ECM 114, the transmission control module 194, and the hybrid control module 196 may be integrated into one or more modules.

Each system that varies an engine parameter may be referred to as an engine actuator. For example, the throttle actuator module 116 may adjust opening of the throttle valve 112 to achieve a target throttle opening area. The spark actuator module 126 controls the spark plugs to achieve a target spark timing relative to piston TDC. The fuel actuator module 124 controls the fuel injectors to achieve target fueling parameters. The phaser actuator module 158 may control the intake and exhaust cam phasers 148 and 150 to achieve target intake and exhaust cam phaser angles, respectively. The EGR actuator module 172 may control the EGR valve 170 to achieve a target EGR opening area. The boost actuator module 164 controls the wastegate 162 to achieve a target wastegate opening area. The cylinder actuator module 120 controls cylinder deactivation to achieve a target number of activated or deactivated cylinders.

The ECM 114 may determine when to activate or deactivate cylinders based on AFM switching thresholds. The AFM switching thresholds may be predetermined. The AFM switching thresholds may also be adjusted by a user. If the user does not adjust the AFM switching thresholds, then the predetermined AFM switching thresholds may be used to determine when to activate or deactivate cylinders. Further, the ECM 114 according to the present disclosure determines whether shifting to a higher gear ratio (i.e., downshifting) with AFM enabled would improve fuel economy over a current lower gear ratio. The ECM 114 may provide an indication that suggests that a driver downshift to improve fuel economy.

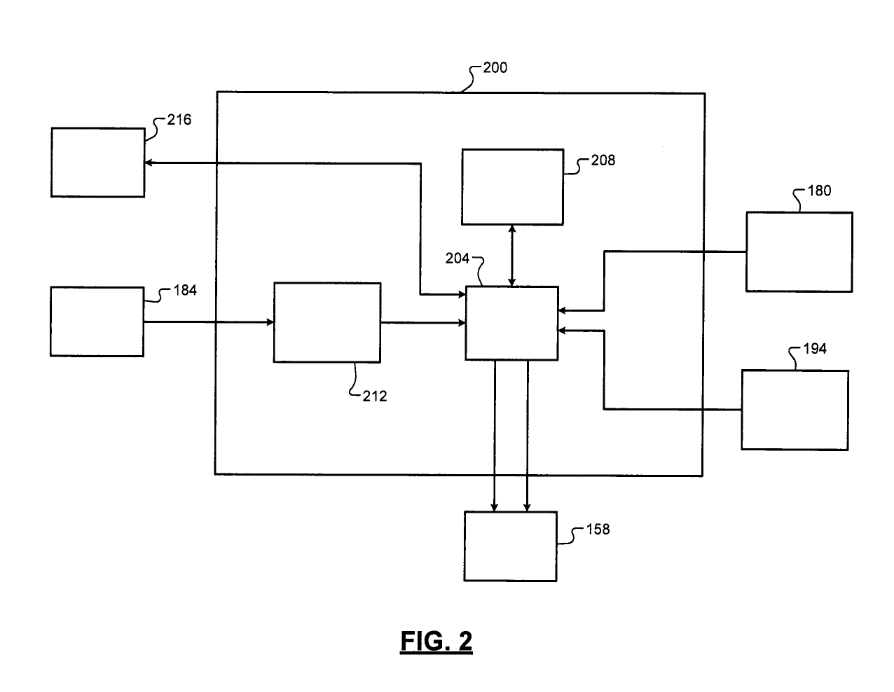

Referring now to FIG. 2, a functional block diagram of an example ECM 200 according to the principles of the present disclosure is shown. An AFM/shift module 204 determines AFM switching thresholds based on, for example, engine speed, a current transmission gear, a percentage of maximum torque, and engine efficiency and shift maps. For example, the engine efficiency and shift maps may be stored in memory 208 (e.g., as lookup tables). The AFM/shift module 204 receives the engine speed from the RPM sensor 180 and the current transmission gear from the transmission control module 194, and a maximum torque module 212 may calculate the percentage of maximum torque based on, for example, a MAP received from the MAP sensor 184.

The shift map may store default AFM switching thresholds. The phaser actuator module 158 controls the intake phaser 150 and the exhaust phaser 152 based on the AFM switching thresholds. For a given set of operating conditions (e.g., current engine speed, transmission gear, etc.), the shift map stores vehicle speed thresholds at which the AFM/shift module 204 may recommend an upshift or a downshift. For example, for a given current transmission gear and engine speed, the shift map may store an upshift vehicle speed threshold and a downshift vehicle speed threshold. If the vehicle speed is greater than the upshift vehicle speed threshold, the AFM/shift module 204 may recommend that a driver upshift. Conversely, if the vehicle speed is less than the downshift vehicle speed threshold, the AFM/shift module 204 may recommend that the driver downshift. For example, the AFM/shift module 204 may provide the recommendations via a user interface/display 216 (e.g., upshift/downshift indicator lights or LEDs).

The AFM/shift module 204 according to the present disclosure implements an AFM shift recommendation method. Accordingly, the AFM/shift module 204 may also recommend a downshift if certain AFM conditions are met. For example, if current torque (in a current gear) does not allow for AFM to be enabled but downshifting to a lower gear would allow for AFM to be enabled, then the AFM/shift module 204 can recommend a downshift to the lower gear. For example only, the AFM/shift module 204 implements the AFM shift recommendation method if the current gear is greater than a minimum gear that allows AFM (i.e., a minimum AFM gear). For example, if AFM is not available in 1^{st} gear, and the current gear is 2^{nd} gear, then the AFM/shift module 204 will not implement the AFM shift recommendation method. Conversely, if the minimum gear that allows AFM is 2^{nd} gear and the current gear is 3^{rd} gear, then the AFM/shift module 204 can implement the AFM shift recommendation method.

For example, if the current gear is greater than the minimum AFM gear, the AFM/shift module 204 may determine an AFM equal fuel consumption (EFC) torque. The AFM EFC torque corresponds to a torque at which AFM should be activated. For example, if a current torque is less than the EFC torque, then AFM should be activated in the current gear. However, if the current torque is greater than or equal to the EFC torque, then AFM should not be activated in the current gear. For example only, EFC torque is determined based on engine speed, the engine efficiency map, and/or other AFM parameters. Accordingly, the EFC torque corresponds to an indication of when AFM demonstrates improved fuel consumption while still meeting torque demands.

If the current torque is greater than or equal to the EFC torque but a lower gear torque (i.e., torque after a downshift) is less than the EFC torque, then the AFM/shift module 204 determines that AFM can be activated after a downshift to the lower gear. Accordingly, if the current torque is greater than or equal to the EFC torque and the lower gear torque is less than the EFC torque, the AFM/shift module 204 recommends a downshift.

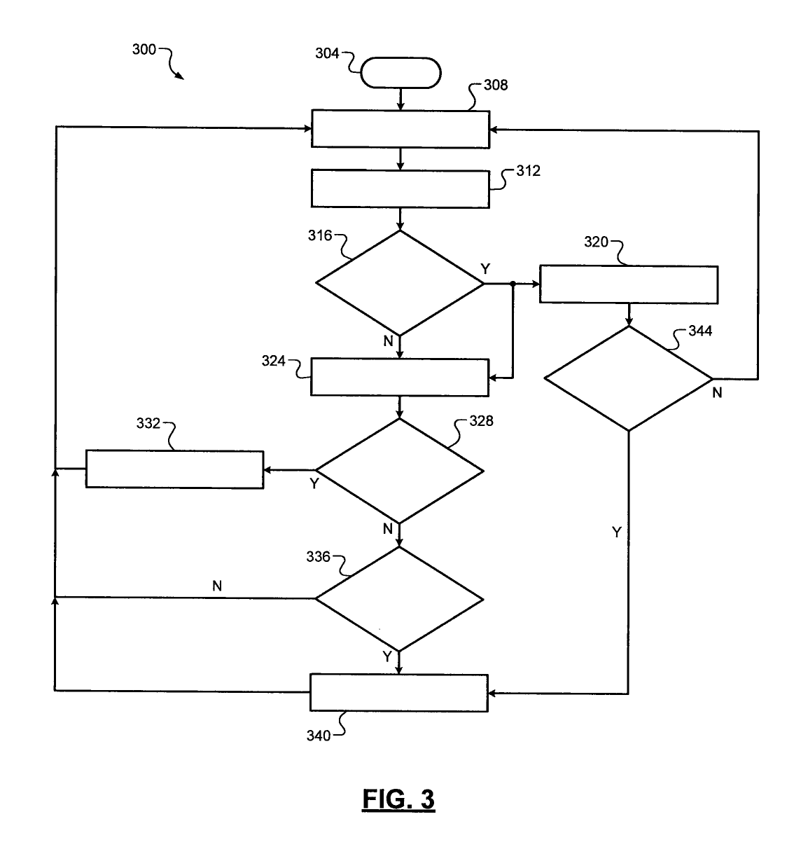

Referring now to FIG. 3, an example AFM shift recommendation method 300 begins at 304. At 308, the method 300 determines an engine speed. At 312, the method 300 determines a current gear. At 316, the method 300 determines whether the current gear is greater than a minimum AFM gear. If true, the method 300 continues to 320 and 324. If false, the method 300 continues to 324. At 324, the method 300 determines vehicle speed. At 328, the method 300 determines whether the vehicle speed is greater than an upshift vehicle speed threshold. If true, the method 300 recommends that the driver perform an upshift (e.g., turns on an upshift indicator light) at 332 and continues to 308. If false, the method 300 determines whether the vehicle speed is less than a downshift vehicle speed threshold at 336. If true, the method 300 recommends that the driver perform a downshift (e.g., turns on a downshift indicator light) at 340 and continues to 308. If false, the method 300 continues to 308.

At 320, the method 300 determines an EFC torque. At 344, the method 300 determines whether conditions are met for performing a downshift to enable AFM. For example, the method 300 determines whether a current torque is greater than the EFC torque and a torque in a next lower gear is less than the EFC torque. If true, the method 300 continues to 340 and recommends that the driver perform a downshift. If false, the method continues to 308.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

What is claimed is:

1. A system, comprising:
a control module that determines a current gear of a vehicle; and
an active fuel management (AFM) and shift module that
determines an upshift vehicle speed threshold and a downshift vehicle speed threshold based in part on the current gear,
selectively provides an indication to a driver to perform a vehicle upshift or an indication to the driver to perform a vehicle downshift based on a comparison between a vehicle speed and each of the upshift vehicle speed threshold and a downshift vehicle speed threshold, and
selectively provides the indication to the driver to perform the vehicle downshift based on a determination that AFM is not enabled in the current gear and that AFM would be enabled in response to the vehicle downshift.

2. The system of claim 1, wherein the AFM and shift module provides the indication to perform the vehicle upshift if the vehicle speed is greater than the upshift vehicle speed threshold.

3. The system of claim 1, wherein the AFM and shift module provides the indication to perform the vehicle downshift if the vehicle speed is less than the downshift vehicle speed threshold.

4. The system of claim 1, wherein providing the indication to perform the vehicle upshift includes activating an upshift indicator light and providing the indication to perform the vehicle downshift includes activating a downshift indicator light.

5. The system of claim 1, wherein the AFM and shift module provides the indication to the driver to perform the vehicle downshift, based on the determination that AFM is not enabled in the current gear and AFM would be enabled in response to the vehicle downshift, if the current gear is greater than a predetermined minimum gear.

6. The system of claim 5, wherein the predetermined minimum gear corresponds to a lowest gear for AFM to be enabled.

7. The system of claim 5, wherein the AFM and shift module provides the indication to the driver to perform the vehicle downshift, based on the determination that AFM is not enabled in the current gear and AFM would be enabled in response to the vehicle downshift, regardless of whether the vehicle speed is greater than the downshift vehicle speed threshold.

8. The system of claim 1, wherein, to determine whether AFM is not enabled in the current gear and AFM would be enabled in response to the vehicle downshift, the AFM and shift module:
determines an AFM torque, wherein the AFM torque corresponds to a torque at which AFM can be enabled in the current gear;
determines whether a current torque is greater than the AFM torque;
determines a downshift torque, wherein the downshift torque corresponds to a torque after a vehicle downshift to a next lower gear; and
determines whether the downshift torque is less than the AFM torque.

9. The system of claim 8, wherein the AFM and shift module provides the indication to perform the vehicle downshift if the current torque is greater than the AFM torque and the downshift torque is less than the AFM torque.

10. A method, comprising:
determining a current gear of a vehicle;
determining an upshift vehicle speed threshold and a downshift vehicle speed threshold based in part on the current gear;
selectively providing an indication to a driver to perform a vehicle upshift or an indication to the driver to perform a vehicle downshift based on a comparison between a vehicle speed and each of the upshift vehicle speed threshold and a downshift vehicle speed threshold; and
selectively providing the indication to the driver to perform the vehicle downshift based on a determination that AFM is not enabled in the current gear and that AFM would be enabled in response to the vehicle downshift.

11. The method of claim 10, further comprising providing the indication to perform the vehicle upshift if the vehicle speed is greater than the upshift vehicle speed threshold.

12. The method of claim 10, further comprising providing the indication to perform the vehicle downshift if the vehicle speed is less than the downshift vehicle speed threshold.

13. The method of claim 10, wherein providing the indication to perform the vehicle upshift includes activating an upshift indicator light and providing the indication to perform the vehicle downshift includes activating a downshift indicator light.

14. The method of claim 10, further comprising providing the indication to the driver to perform the vehicle downshift, based on the determination that AFM is not enabled in the current gear and AFM would be enabled in response to the vehicle downshift, if the current gear is greater than a predetermined minimum gear.

15. The method of claim 14, wherein the predetermined minimum gear corresponds to a lowest gear for AFM to be enabled.

16. The method of claim 14, further comprising providing the indication to the driver to perform the vehicle downshift, based on the determination that AFM is not enabled in the current gear and AFM would be enabled in response to the vehicle downshift, regardless of whether the vehicle speed is greater than the downshift vehicle speed threshold.

17. The method of claim 10, further comprising, to determine whether AFM is not enabled in the current gear and AFM would be enabled in response to the vehicle downshift, the AFM and shift module:
determining an AFM torque, wherein the AFM torque corresponds to a torque at which AFM can be enabled in the current gear;
determining whether a current torque is greater than the AFM torque;
determining a downshift torque, wherein the downshift torque corresponds to a torque after a vehicle downshift to a next lower gear; and
determining whether the downshift torque is less than the AFM torque.

18. The method of claim 17, further comprising providing the indication to perform the vehicle downshift if the current torque is greater than the AFM torque and the downshift torque is less than the AFM torque.
